(19) United States
(12) Patent Application Publication
(10) Pub. No.: US 2023/0153703 A1
(43) Pub. Date: May 18, 2023

(54) METHODS AND SYSTEMS FOR OPTIMIZING PERSONALIZED HOSPITALITY OFFERINGS

(71) Applicant: Tata Consultancy Services Limited, Mumbai (IN)

(72) Inventors: Vijayarangan NATARAJAN, Chennai (IN); Mayank MISHRA, Thane West (IN); Premraj FURTADO, Mumbai (IN); Gaurav SONI, Chennai (IN)

(73) Assignee: Tata Consultancy Services Limited, Mumbai (IN)

(21) Appl. No.: 17/988,002

(22) Filed: Nov. 16, 2022

(30) Foreign Application Priority Data
Nov. 16, 2021 (IN) 202121052596

(51) Int. Cl. G06Q 10/02; G06Q 30/02; G06Q 50/12

(52) U.S. Cl. CPC G06Q 10/02; G06Q 30/0205; G06Q 50/12

(57) ABSTRACT

The present disclosure herein provides methods and systems for optimizing personalized hospitality offerings to suit based on the customer requirement. The present disclosure employs a bucket of prediction models, namely (i) pre-trained hotel prediction model for predicting one or more hotels present in a destination city, (ii) the pre-trained room prediction model for predicting the one or more vacant rooms from the one or more hotels, and (iii) the pre-trained ancillary services prediction model for the predicting the one or more ancillary services available for the one or more vacant rooms. Each prediction model is separately trained on the features obtained from the unstructured historical training data, using a feature extraction technique. The fluidic pricing mechanism is used to provide personalized hospitality offerings by determining the fluidic pricing and offers to multiple relevant ancillary service bundles which may suit mostly to the diverse customers.

### PRIORITY CLAIM

This U.S. patent application claims priority under 35 U.S.C. § 119 to: Indian Patent Application No. 202121052596, filed on 16 Nov. 2021. The entire contents of the aforementioned application are incorporated herein by reference.

### TECHNICAL FIELD

The disclosure herein generally relates to the field of hospitality management, and, more particularly, to methods and systems for optimizing personalized hospitality offerings.

### BACKGROUND

Hospitality business in modern times is focused more on customers especially millennials, who frequently avail the hospitality services across the globe. This segment of customers demands customized and personalized products and the services to suit their lifestyle. However, most of the hotels follow old and traditional approach in providing the hospitality services with stand-alone products. Hence a transformation is required from the way traditional hospitality services is operated, to more versatile and dynamic hospitality services. Hospitality personalization is one of the solutions that is being driven by current market to attract the customers.

The customers in the modern arena expect beyond the core requirement of accommodation (such as room), including hotel product offerings, ancillary services such as food, spa, fitness services, recreational services, and so on. To map the customer requirements, hotels have to offer multiple ancillary products and services along with their core product offerings. However, the desired combination of the accommodation along with the multiple ancillary products and services, varies with each customer. Hence, mapping the combination of the accommodation along with the multiple ancillary products and services, is a daunting task since it differs with each customer. Conventional techniques in the art for the hospitality personalization are limited and may follow manual approaches for making the limited hospitality services and products. However, the limited hospitality services and products may not be effective for diverse customers. Further, machine learning (ML)/artificial intelligence (AI) based conventional techniques are limited in the art and employs a single prediction model for the hospitality services and products, which may not be accurate and effective, due to scarce historical data available in unstructured manner with multiple dimensions.

### SUMMARY

Embodiments of the present disclosure represent technological improvements as solutions to one or more of the above-mentioned technical problems recognized by the inventors in conventional systems.

In an aspect, there is provided a processor-implemented method for optimizing personalized hospitality offerings, the method comprising the steps of: receiving one or more input parameters for the personalized hospitality offerings, from a guest, wherein the one or more input parameters comprising: a number of adults, a number of children, a destination country, a destination city, a type of occupancy, date and time of arrival, date and time of departure, one or more demographic particulars of each adult, one or more demographic particulars of each child, nationality of each adult, nationality of each child, a geographic location of each adult, and a geographic location of each child; identifying one or more hotels available in the destination city, based on the one or more input parameters, using a pre-trained hotel prediction model; identifying one or more vacant rooms available from the one or more hotels, based on the one or more input parameters, using a pre-trained room prediction model; identifying one or more ancillary services associated with each vacant room of the one or more vacant rooms, based on the one or more input parameters, using a pre-trained ancillary services prediction model, wherein the one or more ancillary services associated with each vacant room represents the ancillary services available with each vacant room; forming one or more relevant ancillary service bundles, for each vacant room of the one or more vacant rooms, based on the one or more ancillary services associated with each vacant room and using a mean average precision (MAP) technique; determining a fluidic pricing for each of the one or more relevant ancillary service bundles, for each vacant room of the one or more vacant rooms, using a fluidic pricing procedure; and presenting the personalized hospitality offerings to the guest, using (i) the one or more hotels, (ii) the one or more vacant rooms available from the one or more hotels, (iii) the one or more relevant ancillary service bundles for each vacant room of the one or more vacant rooms, and (iv) the fluidic pricing for each of the one or more relevant ancillary service bundles, for each vacant room of the one or more vacant rooms.

In another aspect, there is provided a system for optimizing the personalized hospitality offerings, the system comprising: a memory storing instructions; one or more Input/Output (I/O) interfaces; and one or more hardware processors coupled to the memory via the one or more I/O interfaces, wherein the one or more hardware processors are configured by the instructions to: receive one or more input parameters for the personalized hospitality offerings, from a guest, wherein the one or more input parameters comprising: a number of adults, a number of children, a destination country, a destination city, a type of occupancy, date and time of arrival, date and time of departure, one or more demographic particulars of each adult, one or more demographic particulars of each child, nationality of each adult, nationality of each child, a geographic location of each adult, and a geographic location of each child; identify one or more hotels available in the destination city, based on the one or more input parameters, using a pre-trained hotel prediction model; identify one or more vacant rooms available from the one or more hotels, based on the one or more input parameters, using a pre-trained room prediction model; identify one or more ancillary services associated with each vacant room of the one or more vacant rooms, based on the one or more input parameters, using a pre-trained ancillary services prediction model, wherein the one or more ancillary services associated with each vacant room represents the ancillary services available with each vacant room; form one or more relevant ancillary service bundles, for each vacant room of the one or more vacant rooms, based on the one or more ancillary services associated with each vacant room and using a mean average precision (MAP) technique; determine a fluidic pricing for each of the one or more relevant ancillary service bundles, for each vacant room of the one or more vacant rooms, using a fluidic pricing procedure; and present the personalized hospitality offerings to the guest, using (i) the one or more hotels, (ii) the one or more vacant rooms available from the one or more hotels, (iii) the one or more relevant ancillary service bundles for each vacant room of the one or more vacant rooms, and (iv) the fluidic pricing for each of the one or more relevant ancillary service bundles, for each vacant room of the one or more vacant rooms.

In yet another aspect, there is provided a computer program product comprising a non-transitory computer readable medium having a computer readable program embodied therein, wherein the computer readable program, when executed on a computing device, causes the computing device to: receive one or more input parameters for the personalized hospitality offerings, from a guest, wherein the one or more input parameters comprising: a number of adults, a number of children, a destination country, a destination city, a type of occupancy, date and time of arrival, date and time of departure, one or more demographic particulars of each adult, one or more demographic particulars of each child, nationality of each adult, nationality of each child, a geographic location of each adult, and a geographic location of each child; identify one or more hotels available in the destination city, based on the one or more input parameters, using a pre-trained hotel prediction model; identify one or more vacant rooms available from the one or more hotels, based on the one or more input parameters, using a pre-trained room prediction model; identify one or more ancillary services associated with each vacant room of the one or more vacant rooms, based on the one or more input parameters, using a pre-trained ancillary services prediction model, wherein the one or more ancillary services associated with each vacant room represents the ancillary services available with each vacant room; form one or more relevant ancillary service bundles, for each vacant room of the one or more vacant rooms, based on the one or more ancillary services associated with each vacant room and using a mean average precision (MAP) technique; determine a fluidic pricing for each of the one or more relevant ancillary service bundles, for each vacant room of the one or more vacant rooms, using a fluidic pricing procedure; and present the personalized hospitality offerings to the guest, using (i) the one or more hotels, (ii) the one or more vacant rooms available from the one or more hotels, (iii) the one or more relevant ancillary service bundles for each vacant room of the one or more vacant rooms, and (iv) the fluidic pricing for each of the one or more relevant ancillary service bundles, for each vacant room of the one or more vacant rooms.

In an embodiment, the pre-trained hotel prediction model is obtained by: receiving a historical hotel reservation training dataset comprising a plurality of hotel historical records, wherein each hotel historical record represents a hotel reservation data associated with a past guest and comprising at least one of: a destination country of the past guest, a destination city of the past guest, a hotel name availed by the past guest, date and time of arrival of the past guest, nationality of the past guest, type of occupancy reserved by the past guest; pre-processing the historical hotel reservation training dataset to obtain a pre-processed historical hotel reservation training dataset comprising a plurality of pre-processed hotel historical records, wherein each pre-processed hotel historical record represents a pre-processed reservation data associated with the past guest, and wherein the pre-processing comprises at least one of: cleaning, imputing missing data, and outliers removal; extracting a plurality of first features from the plurality of pre-processed hotel historical records, using a feature extraction technique, wherein each first feature is extracted from each pre-processed hotel historical record; and training a random forest model with the plurality of first features, to obtain the pre-trained hotel prediction model.

In an embodiment, the pre-trained room prediction model is obtained by: receiving a historical room reservation training dataset comprising a plurality of room historical records, wherein each room historical record represents a room reservation data associated with a past guest and comprising at least one of: a destination country of the past guest, a destination city of the past guest, a hotel name availed by the past guest, a type of occupancy availed by the past guest in the hotel, date and time of arrival of the past guest, and nationality of the past guest; pre-processing the historical room reservation training dataset to obtain a pre-processed historical room reservation training dataset comprising a plurality of pre-processed room historical records, wherein each pre-processed room historical record represents a pre-processed room reservation data associated with the past guest, and wherein the pre-processing comprises at least one of: cleaning, imputing missing data, and outliers removal; extracting a plurality of second features from the plurality of pre-processed room historical records, using a feature extraction technique, wherein each second feature is extracted from each pre-processed room historical record; and training a random forest model with the plurality of second features, to obtain the pre-trained room prediction model.

In an embodiment, the pre-trained ancillary services prediction model is obtained by: receiving a historical ancillary services reservation training dataset comprising a plurality of historical ancillary services reservation records, wherein each historical ancillary services reservation records represents an ancillary services reservation data associated with a past guest, and comprising at least one of: a destination country of the past guest, a destination city of the past guest, a hotel name availed by the past guest, date and time of arrival of the past guest, date and time of departure of the past guest, nationality of the past guest, type of occupancy availed by the past guest in the hotel, and one or more ancillary services availed by the past guest; pre-processing the historical ancillary services reservation training dataset to obtain a pre-processed historical ancillary services reservation training dataset comprising a plurality of pre-processed historical ancillary services reservation records, wherein each pre-processed historical ancillary services reservation record represents a pre-processed ancillary services reservation data associated with the past guest, and wherein the pre-processing comprises at least one of: cleaning, imputing missing data, and outliers removal; extracting a plurality of third features from the plurality of pre-processed historical ancillary services reservation records, using a feature extraction technique, wherein each third feature is extracted from each pre-processed historical ancillary services reservation record; and training a XG-boost model with the plurality of third features, to obtain the pre-trained ancillary service prediction model.

In an embodiment, the one or more relevant ancillary service bundles, for each vacant room, are formed based on the one or more ancillary services associated with each vacant room and a mean average precision (MAP) technique, by: assigning a rank to each of the one or more ancillary services associated with each vacant room, based on a population score of each of the one or more ancillary services, wherein the population score of each of the one or more ancillary services is obtained by a pre-trained population score prediction model; forming a plurality of ancillary service bundles, for each vacant room, based on the one or more ancillary services associated with each vacant room; calculating a MAP score for each ancillary service bundle of the plurality of ancillary service bundles, for each vacant room, using the rank assigned to each of the one or more ancillary services associated with the vacant room; and forming the one or more ancillary service bundles out of the plurality of ancillary service bundles, having the MAP score for each ancillary service bundle of the plurality of ancillary service bundles greater than a predefined threshold, for each vacant room; defining an average precision (AP) score, for each vacant room of the one or more vacant rooms, using an average precision technique; calculating a morphism score for each of the one or more ancillary service bundles, for each vacant room, based on the average precision (AP) score for each vacant room and the MAP score for the corresponding ancillary service bundle associated with the vacant room, using a predefined morphism criterion; and determining one or more relevant ancillary service bundles, from the one or more ancillary service bundles, based on the relevant ancillary service bundle score for each of the one or more ancillary service bundles.

In an embodiment, the fluidic pricing for each of the one or more relevant ancillary service bundles, for each vacant room of the one or more vacant rooms, is determined, using the fluidic pricing procedure, by: calculating a number of ancillary services present in each of the one or more relevant ancillary service bundles, for each vacant room of the one or more vacant rooms; calculating an ancillary services average, based on the number of ancillary services present in each of the one or more relevant ancillary service bundles, for each vacant room; calculating (i) an ancillary services standard deviation and (ii) an ancillary services variance, based on the ancillary services average; calculating (i) an ancillary services covariance and (ii) an ancillary services Fano-factor, based on the ancillary services average, the ancillary services standard deviation, and the ancillary services variance; calculating a correlation factor, based on the ancillary services covariance and the ancillary services Fano-factor, using a correlation equation; calculating (i) a lower bound, and (ii) an upper bound, for each of the one or more relevant ancillary service bundles, using the correlation factor and a MAP score associated with each of the one or more relevant ancillary service bundles; classifying each of the one or more ancillary service bundles, based on the lower bound, and the upper bound associated ancillary service bundle, to calculate a deterministic offer for each of the one or more relevant ancillary service bundles, based on the classification and a maximum deterministic offer defined for each of the one or more ancillary service bundles; determining a fluidic offer for each of the one or more relevant ancillary service bundles, based on the deterministic offer calculated for each of the one or more relevant ancillary service bundles; calculating a negotiated offer value for each of the one or more relevant ancillary service bundles, based on the deterministic offer and the fluidic offer associated with each of the one or more ancillary service bundles; calculating a stochastic offer price for each of the one or more ancillary service bundles, based on the negotiated offer value corresponding to the ancillary service bundle and an actual price value corresponding to the ancillary service bundle; calculating a relevant stochastic ancillary service bundle price for each of the one or more ancillary service bundles, based on the stochastic offer price corresponding to the ancillary service bundle and the actual price value corresponding to the ancillary service bundle; calculating a linear offer for each of the one or more relevant ancillary service bundles, based on the actual price value corresponding to the relevant ancillary service bundle and the deterministic offer corresponding to the relevant ancillary service bundle; calculating a relevant linear ancillary service bundle price for each of the one or more ancillary service bundles, based on the actual price value corresponding to the relevant ancillary service bundle and the linear offer corresponding to the relevant ancillary service bundle; and determining the fluidic pricing for each of the one or more relevant ancillary service bundles, based on (i) the relevant stochastic ancillary service bundle price for each of the one or more ancillary service bundles, and (ii) the relevant linear ancillary service bundle price for each of the one or more ancillary service bundles.

It is to be understood that both the foregoing general description and the following detailed description are exemplary and explanatory only and are not restrictive of the embodiments of the present disclosure, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles:

FIG. 1 is an exemplary block diagram of a system for optimizing personalized hospitality offerings, in accordance with some embodiments of the present disclosure.

FIG. 2 is an exemplary block diagram illustrating modules of the system of FIG. 1 for optimizing the personalized hospitality offerings, in accordance with some embodiments of the present disclosure.

FIG. 3A and FIG. 3B illustrate exemplary flow diagrams of a processor-implemented method for optimizing the personalized hospitality offerings, in accordance with some embodiments of the present disclosure.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the scope of the disclosed embodiments.

The present disclosure herein provides methods and systems for optimizing personalized hospitality offerings, to solve the technical problems for providing diverse hospitality services and products to suit based on the customer requirement. The present disclosure employs a plurality of prediction models for optimizing the personalized hospitality offerings, wherein each prediction model is separately trained on the features obtained from the unstructured historical training data. Further, a fluidic pricing mechanism is employed to provide the multiple products and services along with the offers and discounts, which may suit mostly to the diverse customers.

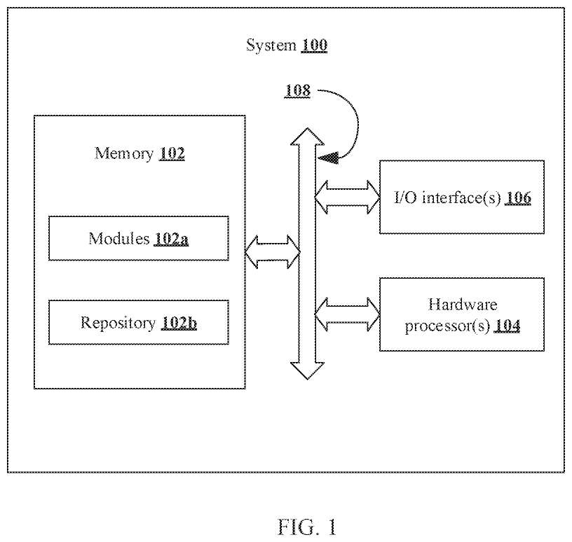

Referring now to the drawings, and more particularly to FIG. 1 through FIG. 3B, where similar reference characters denote corresponding features consistently throughout the figures, there are shown preferred embodiments and these embodiments are described in the context of the following exemplary systems and/or methods.

FIG. 1 is an exemplary block diagram of a system 100 for optimizing personalized hospitality offerings, in accordance with some embodiments of the present disclosure. In an embodiment, the system 100 includes or is otherwise in communication with one or more hardware processors 104, communication interface device(s) or input/output (I/O) interface(s) 106, and one or more data storage devices or memory 102 operatively coupled to the one or more hardware processors 104. The one or more hardware processors 104, the memory 102, and the I/O interface(s) 106 may be coupled to a system bus 108 or a similar mechanism.

The I/O interface(s) 106 may include a variety of software and hardware interfaces, for example, a web interface, a graphical user interface, and the like. The I/O interface(s) 106 may include a variety of software and hardware interfaces, for example, interfaces for peripheral device(s), such as a keyboard, a mouse, an external memory, a plurality of sensor devices, a printer and the like. Further, the I/O interface(s) 106 may enable the system 100 to communicate with other devices, such as web servers and external databases.

The I/O interface(s) 106 can facilitate multiple communications within a wide variety of networks and protocol types, including wired networks, for example, local area network (LAN), cable, etc., and wireless networks, such as Wireless LAN (WLAN), cellular, or satellite. For the purpose, the I/O interface(s) 106 may include one or more ports for connecting a number of computing systems with one another or to another server computer. Further, the I/O interface(s) 106 may include one or more ports for connecting a number of devices to one another or to another server.

The one or more hardware processors 104 may be implemented as one or more microprocessors, microcomputers, microcontrollers, digital signal processors, central processing units, state machines, logic circuitries, and/or any devices that manipulate signals based on operational instructions. Among other capabilities, the one or more hardware processors 104 are configured to fetch and execute computer-readable instructions stored in the memory 102. In the context of the present disclosure, the expressions ‘processors’ and ‘hardware processors’ may be used interchangeably. In an embodiment, the system 100 can be implemented in a variety of computing systems, such as laptop computers, portable computers, notebooks, hand-held devices, workstations, mainframe computers, servers, a network cloud and the like.

The memory 102 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. In an embodiment, the memory 102 includes a plurality of modules 102a and a repository 102b for storing data processed, received, and generated by one or more of the plurality of modules 102a. The plurality of modules 102a may include routines, programs, objects, components, data structures, and so on, which perform particular tasks or implement particular abstract data types.

The plurality of modules 102a may include programs or computer-readable instructions or coded instructions that supplement applications or functions performed by the system 100. The plurality of modules 102a may also be used as, signal processor(s), state machine(s), logic circuitries, and/or any other device or component that manipulates signals based on operational instructions. Further, the plurality of modules 102a can be used by hardware, by computer-readable instructions executed by the one or more hardware processors 104, or by a combination thereof. In an embodiment, the plurality of modules 102a can include various sub-modules (not shown in FIG. 1). Further, the memory 102 may include information pertaining to input(s)/output(s) of each step performed by the processor(s) 104 of the system 100 and methods of the present disclosure.

The repository 102b may include a database or a data engine. Further, the repository 102b amongst other things, may serve as a database or includes a plurality of databases for storing the data that is processed, received, or generated as a result of the execution of the plurality of modules 102a. Although the repository 102b is shown internal to the system 100, it will be noted that, in alternate embodiments, the repository 102b can also be implemented external to the system 100, where the repository 102b may be stored within an external database (not shown in FIG. 1) communicatively coupled to the system 100. The data contained within such external database may be periodically updated. For example, new data may be added into the external database and/or existing data may be modified and/or non-useful data may be deleted from the external database. In one example, the data may be stored in an external system, such as a Lightweight Directory Access Protocol (LDAP) directory and a Relational Database Management System (RDBMS). In another embodiment, the data stored in the repository 102b may be distributed between the system 100 and the external database.

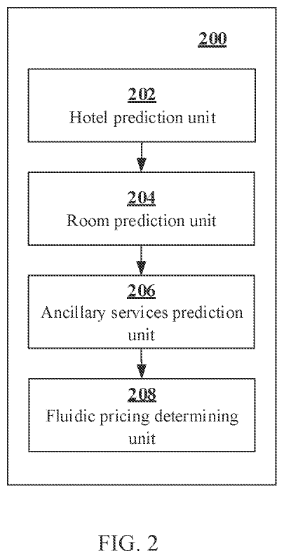

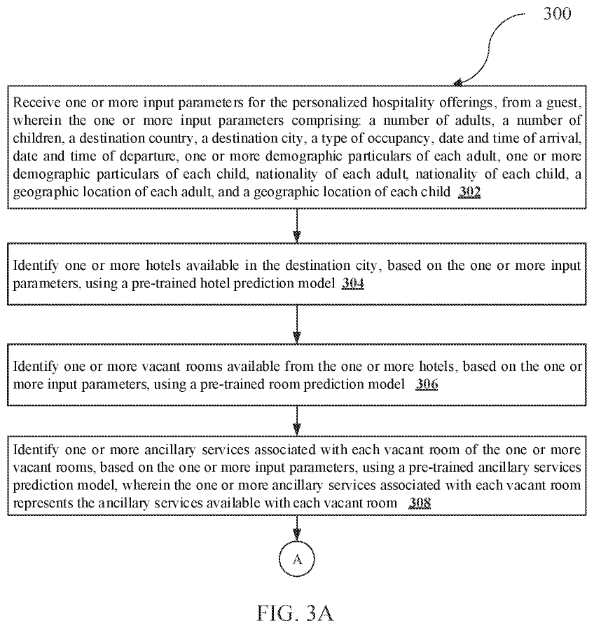

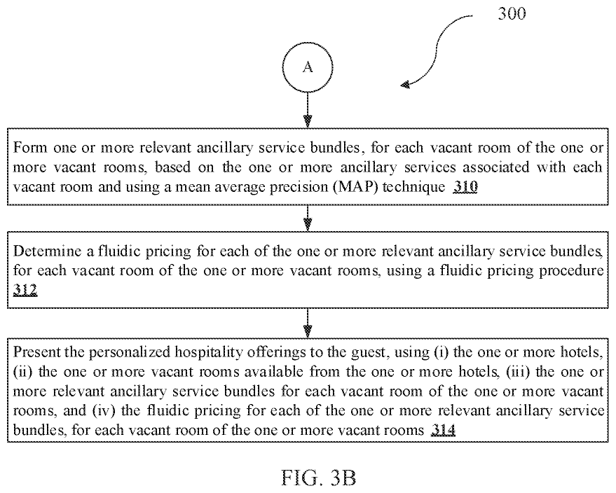

Referring collectively to FIG. 2 and FIG. 3A-3B, components and functionalities of the system 100 are described in accordance with an example embodiment of the present disclosure. For example, FIG. 2 is an exemplary block diagram illustrating modules 200 of the system 100 of FIG. 1 for optimizing the personalized hospitality offerings, in accordance with some embodiments of the present disclosure. As shown in FIG. 2, the modules 200 include a hotel prediction unit 202, a room prediction unit 204, an ancillary services prediction unit 206, and a fluidic pricing determining unit 208. In an embodiment, the modules 200 of FIG. 2 may be stored in the plurality of modules 102a comprised in the memory 102 of the system 100.

FIG. 3A and FIG. 3B illustrate exemplary flow diagrams of a processor-implemented method 300 for optimizing the personalized hospitality offerings, in accordance with some embodiments of the present disclosure. Although steps of the method 300 including process steps, method steps, techniques or the like may be described in a sequential order, such processes, methods and techniques may be configured to work in alternate orders. In other words, any sequence or order of steps that may be described does not necessarily indicate a requirement that the steps be performed in that order. The steps of processes described herein may be performed in any practical order. Further, some steps may be performed simultaneously, or some steps may be performed alone or independently.

In the context of the present disclosure, the terms ‘guest’, ‘customer’, ‘user’ may be interchangeably used based on the context defines a person or an entity who wishes to book a room or an accommodation, for himself, herself, or along with the family, or for their customers, employees, and so on.

At step 302 of the method 300, the one or more hardware processors 104 of the system 100 are configured to receive one or more input parameters for optimizing the personalized hospitality offerings, from a guest. The guest may be a customer, an agent, or an entity looking for the personalized hospitality offerings. Further, the guest may book the personalized hospitality offerings for himself, or along with family members, or only for family members, or for their customers. The agent may be a third-party agent who may book the personalized hospitality offerings for their customers.

The one or more input parameters including: a number of adults, a number of children, a destination country, a destination city, a type of occupancy, date and time of arrival, date and time of departure, one or more demographic particulars of each adult, one or more demographic particulars of each child, nationality of each adult, nationality of each child, a geographic location of each adult, and a geographic location of each child. The one or more parameters defines the number of persons going to stay in a hotel, and requirement of number of rooms with specific requirements. The adult and child may be differentiated based on the age of a person and may differ for each hotel. For example, some hotels may define the age more than 8 years may treat as adult and some hotels may define the age less than 5 years may treat as child, and so on. Further, some hotels may treat infants based on their age, neither as the adult or the child.

The destination country defines the name of the country the persons are interested to stay, and the destination city defines the name of the place the persons are interested to stay in the destination country. In an embodiment, only the destination city may be requested, and the corresponding destination country may be automatically determined based on the destination city. A type of occupancy defines the occupancy type of the room and the guest may choose number of rooms required based on the type of occupancy. In an embodiment, the type of occupancy, may be single room, double room, deluxe room, luxury room, suite, deluxe suite, and so on. Each type of occupancy may have certain defined standards with defined amenities.

The date and time of arrival defines the date and time of arrival of the person for which the accommodation is required. The date and time of departure defines the date and time of departures of the persons to which the accommodation is required. The time difference between the date and time of arrival and the date and time of departure defines the number of days during which the accommodation is required. In an embodiment, only the date and time of arrival and the number of days during which the accommodation is required, may only be received instead of the date and time of departure.

The one or more demographic particulars of each adult and each child may include demographic details such as male or female, age, height, differently abled people, and so on. The nationality of each adult and the nationality of each child defines the country in which the adult of the child is born or having a permanent resident right. In an embodiment, the nationality of each adult and the nationality of each child may help to identify interests, or requirements during the stay, or a most preferred hotel in the destination city. The geographic location of each adult, and the geographic location of each child may be obtained based on a global positioning system (GPS) location or the internet protocol (IP) address present in the input device of the guest.

In an embodiment, some parameters out of the one or more input parameters may be optional, while some parameters may be mandatory. For example, the number of adults, the number of children and the date and time of arrival may be mandatory, while others are optional. In another embodiment, the number of the one or more input parameters may be same or different to each hotel. More specifically some of the one or more input parameters that are mandate for one hotel, may not be same for another hotel.

At step 304 of the method 300, the one or more hardware processors 104 of the system 100 are configured to identify one or more hotels that are available in the destination city, based on the one or more input parameters received at step 302 of the method 300. A pre-trained hotel prediction model is used to identify the one or more hotels, based on the specifications and the requirements defined by the guest in the form of the one or more input parameters. Further, the pre-trained hotel prediction model uses some of the input parameters to identify and filter the suitable hotels present in the destination city. More specifically, the pre-trained hotel prediction model may identify a predefined number of hotels having higher reputation and ratings, out of all the hotels present in the destination city. The pre-trained hotel prediction model may be stored in the hotel prediction unit 202 of FIG. 2.

The pre-trained hotel prediction model is obtained by training a random forest model with a historical hotel reservation training dataset. The historical hotel reservation training dataset includes a plurality of historical hotel records, wherein each historical hotel record represents a hotel reservation data associated with a past guest. The past guest is the customer who availed the hotel in the past for stay in the destination city. Each historical hotel record includes the information for at least one of: a destination country of the past guest, a destination city of the past guest, a hotel name availed by the past guest, date and time of arrival of the past guest, nationality of the past guest, type of occupancy reserved by the past guest.

The historical hotel reservation training dataset is pre-processed, to obtain a pre-processed historical hotel reservation training dataset including a plurality of pre-processed historical hotel records. Each pre-processed historical hotel record represents a pre-processed reservation data associated with the past guest. The pre-processing includes at least one of: cleaning, imputing missing data, and outliers removal. In an embodiment, cleaning process includes making the record in the standard process and removing the metadata available with each record. In an embodiment, the outliers removal process includes removing the record associated with the guest who availed the hotel for short duration (stay). In an embodiment, an interquartile range (IQR) technique may be employed to remove the outliers. In an embodiment, imputing the missing data includes filling the missing data by using data imputing techniques such as statistical methods.

The plurality of pre-processed historical hotel records is then used to extract a plurality of first features, wherein each first feature is extracted from each pre-processed historical hotel record. A feature extraction technique such a personalized framework is used to extract the plurality of first features from the plurality of pre-processed historical hotel records. Each first feature may include the data present in each pre-processed historical hotel record, in the form of four segments comprising customer, action, entity and context. The segment ‘customer’ represents the guest who takes the action (represents the segment ‘action’) on an entity (represents the segment ‘entity’, based on the context (represents the segment ‘context’). For example, guest A (segment ‘customer’) availed (the segment ‘action’) a suite room (the segment ‘entity’) in hotel A (the segment ‘entity’) having a free kids game zone, as guest A staying with 2 kids (the segment ‘context’).

Lastly, the random forest model is trained with the plurality of first features, to obtain the pre-trained hotel prediction model. In each first feature, the data related to ‘hotel name’ is passed an output variable and the remaining data as input variables during the training process. The random forest model creates a set of decision trees from the plurality of first features and collects the votes from each decision tree based on the target variable to make the prediction in the form predefined number of hotel names present in the destination city based on the input variables.

The pre-trained hotel prediction model is validated using a hotel validation dataset and based on a hotel confusion matrix, to determine the performance and the training process may be iteratively performed until a predefined accuracy is achieved by the pre-trained hotel prediction model. The obtained pre-trained hotel prediction model after the validation is then used to identify the one or more hotels (hotel names) present in the destination city.

At step 306 of the method 300, the one or more hardware processors 104 of the system 100 are configured to identify one or more vacant rooms available from the one or more hotels identified at step 304 of the method, based on the one or more input parameters received at step 302 of the method 300. A pre-trained room prediction model is used to identify the one or more rooms from the one or more hotels, based on the specifications and the requirements defined by the guest in the form of the one or more input parameters. Further, the pre-trained room prediction model uses some of the input parameters out of the one or more input parameters, to identify and filter the suitable rooms present in each identified hotel. More specifically, the pre-trained room prediction model considers the number of adults, the number of children, date and time of arrival, and the type of occupancy to predict the vacant rooms available in each hotel. The pre-trained room prediction model may be stored in the room prediction unit 204 of FIG. 2.

The pre-trained room prediction model is obtained by training the random forest model with a historical room reservation training dataset. The historical room reservation training dataset includes a plurality of historical room records, wherein each historical room record represents a room reservation data associated with a past guest. The past guest is the customer who availed the room in the hotel in the past for stay in the destination city. Each historical room record includes information for at least one of: destination country of the past guest, a destination city of the past guest, a hotel name availed by the past guest, a type of occupancy availed by the past guest in the hotel, date and time of arrival of the past guest, and nationality of the past guest.

The historical room reservation training dataset is pre-processed, to obtain a pre-processed historical room reservation training dataset including a plurality of pre-processed historical room records. Each pre-processed historical room record represents a pre-processed room reservation data associated with the past guest. The pre-processing includes at least one of: cleaning, imputing missing data, and outliers removal. In an embodiment, cleaning process includes making the record in the standard process and removing the metadata available with each record. In an embodiment, the outliers removal process includes removing the record associated with the guest who availed the room in the hotel for short duration (stay). In an embodiment, imputing the missing data including filling the missing data by using data imputing techniques such as statistical methods.

The plurality of pre-processed historical room records is then used to extract a plurality of second features, wherein each second feature is extracted from each pre-processed historical room record. A feature extraction technique such a personalized framework is used to extract the plurality of second features from the plurality of pre-processed historical room records. Each second feature may include the data present in each pre-processed historical room record, in the form of four segments comprising customer, action, entity and context. The segment ‘customer’ represents the guest who takes the action (represents the segment ‘action’) on an entity (represents the segment ‘entity’, based on the context (represents the segment ‘context’). For example, guest A (segment ‘customer’) availed (the segment ‘action’) a suite room (the segment ‘entity’) in hotel A (the segment ‘entity’) having a free kids game zone, as guest A staying with 2 kids (the segment ‘context’).

Lastly, the random forest model is trained with the plurality of second features, to obtain the pre-trained room prediction model. In each second feature, the data related to ‘room’ (more particularly, the ‘type of occupancy’) is passed an output variable and the remaining data as input variables during the training process. The random forest model creates a set of decision trees from the plurality of second features and collects the votes from each decision tree based on the target variable to make the prediction in the form of rooms present in each identified hotel, in the destination city based on the input variables.

The pre-trained room prediction model is validated using a room validation dataset and based on a room confusion matrix, to determine the performance and the training process may be iteratively performed until a predefined accuracy is achieved by the pre-trained room prediction model. The obtained pre-trained room prediction model after the validation is then used to identify the one or more rooms present in each of the one or more hotels in the destination city.

At step 308 of the method 300, the one or more hardware processors 104 of the system 100 are configured to identify one or more ancillary services associated with each vacant room of the one or more vacant rooms identified at step 306 of the method, based on the one or more input parameters received at step 302 of the method 300. A pre-trained ancillary services prediction model is used to identify the one or more ancillary services for each vacant room, based on the specifications and the requirements defined by the guest in the form of the one or more input parameters.

Further, the pre-trained ancillary services prediction model uses some of the input parameters out of the one or more input parameters, to identify and filter the suitable ancillary services that may be available for the identified vacant room by the identified hotel. More specifically, the pre-trained ancillary services prediction model considers the number of adults, the number of children, date and time of arrival, the type of occupancy, the one or more demographic particulars of each adult, the one or more demographic particulars of each child, the nationality of each adult, and the nationality of each child, to predict the one or more ancillary services for each vacant room. Some of the ancillary services include saloon, breakfast, candle-light dinner, spa, games, sports, swimming, and so on. The pre-trained ancillary services prediction model may be stored in the ancillary services prediction unit 206 of FIG. 2.

The pre-trained ancillary services prediction model is obtained by training an XG-boost model with a historical ancillary services reservation training dataset. The historical ancillary services reservation training dataset includes a plurality of historical ancillary services reservation records, wherein each historical ancillary services reservation record represents the ancillary services reservation data associated with the past guest. The past guest is the customer who availed the room along with the ancillary services in the hotel in the past for stay in the destination city. Each historical ancillary services reservation record includes information for at least one of: the destination country of the past guest, the destination city of the past guest, the hotel name availed by the past guest, date and time of arrival of the past guest, date and time of departure of the past guest, nationality of the past guest, type of occupancy availed by the past guest in the hotel, the one or more demographic particulars of the past guest, the nationality of the past guest, and one or more ancillary services availed by the past guest.

The historical ancillary services reservation training dataset is pre-processed, to obtain a pre-processed historical ancillary services reservation training dataset including a plurality of pre-processed historical ancillary services reservation records. Each pre-processed historical ancillary services reservation record represents a pre-processed ancillary services reservation data associated with the past guest. The pre-processing includes at least one of: cleaning, imputing missing data, and outliers removal. In an embodiment, cleaning process includes making the record in the standard process and removing the metadata available with each record. In an embodiment, the outliers removal process includes removing the record associated with the guest who availed the room in the hotel for short duration (stay). In an embodiment, imputing the missing data including filling the missing data by using data imputing techniques such as statistical methods.

The plurality of pre-processed historical ancillary services reservation records is then used to extract a plurality of third features, wherein each third feature is extracted from each pre-processed historical ancillary services reservation record. A feature extraction technique such the personalized framework is used to extract the plurality of third features from the plurality of pre-processed historical ancillary services reservation records. Each third feature may include the data present in each pre-processed historical ancillary services reservation record, in the form of four segments comprising customer, action, entity and context. The segment ‘customer’ represents the guest who takes the action (represents the segment ‘action’) on an entity (represents the segment ‘entity’, based on the context (represents the segment ‘context’). For example, guest A (segment ‘customer’) availed (the segment ‘action’) a swimming pool service (the segment ‘entity’) in hotel A (the segment ‘entity’) for his 2 kids (the segment ‘context’).

Lastly, the XG-boost model is trained with the plurality of third features, to obtain the pre-trained ancillary services prediction model. In each second feature, the data related to ‘ancillary services’ is passed as output variables and the remaining data as input variables during the training process. The XG-boost model computes a score for each output variable, based on the set of input variables to make the prediction.

The pre-trained ancillary services prediction model is validated using an ancillary services validation dataset and based on an ancillary services confusion matrix, to determine the performance and the training process may be iteratively performed until a predefined accuracy is achieved by the pre-trained ancillary services prediction model. The obtained pre-trained ancillary services prediction model after the validation is then used to identify the one or more ancillary services associated with each vacant room of the one or more vacant rooms.

At step 310 of the method 300, the one or more hardware processors 104 of the system 100 are configured to form one or more relevant ancillary service bundles, for each vacant room of the one or more vacant rooms, based on the one or more ancillary services identified for each vacant room at step 308 of the method 300. and using a mean average precision (MAP) technique. Each relevant ancillary service bundle includes at least some of the ancillary services out of the one or more ancillary services identified for each vacant room.

In order to form the one or more relevant ancillary service bundles, firstly, a rank is assigned to each of the one or more ancillary services associated with each vacant room obtained at step 308 of the method 300, based on a population score of each of the one or more ancillary services. In an embodiment, the population score of each ancillary service defines how much the popularity (most likely, least likely, recommended, and so on) of the ancillary service that is available for the vacant room in the hotel. The ancillary service having the highest population score is assigned with a higher rank. Similarly, the ancillary service having the lowest population score is assigned with a lower rank. For example, the ancillary service having the highest population score is assigned with the rank ‘1’, the ancillary service having the next highest population score is assigned with the rank ‘2’, and so on, in the sequential order. If two or more ancillary services having the same population score, then, the same rank is assigned to each ancillary service having the same population score.

The population score of each ancillary service is obtained by a pre-trained population score prediction model. In an embodiment, the pre-trained population score prediction model is trained on the ancillary services historical training data and is configured to output; (i) a higher population score for the ancillary service that is most often availed in the past, and (ii) a least population score for the ancillary service that is least likely availed in the past.

Next, a plurality of ancillary service bundles is formed for each vacant room, either randomly or sequentially, based on the one or more ancillary services associated with each vacant room. Further, a Mean Average Precision (MAP) score for each ancillary service bundle of the plurality of ancillary service bundles, for each vacant room, is calculated, using the rank assigned to each of the one or more ancillary services associated with the vacant room. The MAP score for each ancillary service bundle, defines an overall score of the ancillary services present in the corresponding ancillary service bundle.

Next, out of the plurality of ancillary service bundles, one or more ancillary service bundles having the MAP score greater than a predefined threshold, are identified, and formed, for each vacant room. Further, an average precision (AP) score for each vacant room of the one or more vacant rooms, is defined using an average precision technique. In an embodiment, the predefined threshold ranges between 0 and 1, more specifically the predefined threshold may be 0.13. The average precision technique defines a higher precision for the room having superior qualities and a lower precision for the room having low qualities. The average precision (AP) score for each vacant room is then defined based on the precision of the room. In other words, the suite room is generally treated as highest room class type and the AP score for such room class is assigned with highest score, for example, ‘0.90’. Similarly, the single bedroom is generally treated as low room class type and the AP score for such room class is assigned with lowest score, for example, ‘0.25’.

Next a morphism score for each of the one or more ancillary service bundles, for each vacant room, is calculated, based on the average precision (AP) score for each vacant room and the MAP score for the corresponding ancillary service bundle associated with the vacant room, using a predefined morphism criterion. The predefined morphism criterion defines a relation between the ancillary service bundle and the vacant room based on the class type, in the form of morphism. The predefined morphism criterion includes:
(i) f(a,b)=a+b−ab, is a semigroup with identity between [0,1], where a is the MAP score for the corresponding ancillary service bundle, b is the average precision (AP) score for the corresponding vacant room, and f(a,b) is the morphism score;
(ii) g(a,b)=(a+b)/2, is a semigroup with identity between [0,1], where a is the MAP score for the corresponding ancillary service bundle, b is the average precision (AP) score for the corresponding vacant room, and g(a,b) is the morphism score; and
(iii) h(a,b)=2ab/(a+b), is a semigroup with identity between [0,1], where a is the MAP score for the corresponding ancillary service bundle, b is the average precision (AP) score for the corresponding vacant room, and h(a,b) is the morphism score.

Lastly, one or more relevant ancillary service bundles are determined from the one or more ancillary service bundles, for each vacant room, based on the relevant ancillary service bundle score for each of the one or more ancillary service bundles. For example, the ancillary service bundle having the height morphism score is considered as the relevant ancillary service bundles for the associated vacant room. Table 1 shows exemplary relevant ancillary service bundles for the exemplary vacant room.

TABLE 1

| Relevant ancillary | Relevant ancillary service |
|---|---|
| service bundle number | bundle |
| Bundle 1 | {Breakfast, Dinner, Saloon, |
| | SPA} |
| Bundle 2 | {Breakfast, Dinner, Saloon} |
| Bundle 3 | {Breakfast, Dinner, SPA} |
| Bundle 4 | {Breakfast, Dinner} |
| Bundle 5 | {Breakfast, Saloon, SPA} |
| Bundle 6 | {Breakfast, Saloon} |
| Bundle 7 | {Breakfast, SPA} |
| Bundle 8 | {Breakfast} |

At step 312 of the method 300, the one or more hardware processors 104 of the system 100 are configured to determine a fluidic pricing for each of the one or more relevant ancillary service bundles formed at step 310 of the method 300, for each vacant room of the one or more vacant rooms, using a fluidic pricing procedure. The fluidic pricing for each of the one or more relevant ancillary service bundles, defines the best offer price for the associated relevant ancillary service bundle. Further, the guest may make changes in the ancillary services dynamically, and the fluidic pricing for such relevant ancillary service bundle may be changed appropriately based on the interest and requirements of the guest. The fluidic pricing procedure may be stored in the fluidic pricing determining unit 208 of FIG. 2.

The fluidic pricing procedure for determining the fluidic pricing for each of the one or more relevant ancillary service bundles, is explained in the below steps. Firstly, a number of ancillary services present in each of the one or more relevant ancillary service bundles, is calculated for each vacant room of the one or more vacant rooms. For example, the number of ancillary services present in bundle 1 shown in table 1, is ‘4’. Next, an ancillary services average is calculated based on the number of ancillary services present in each of the one or more relevant ancillary service bundles, for each vacant room. Further, (i) an ancillary services standard deviation and (ii) an ancillary services variance, are determined based on the ancillary services average. A standard statistical standard deviation and variance equations are employed to determine the ancillary services standard deviation and the ancillary services variance, respectively.

Next, (i) an ancillary services covariance (CoV) and (ii) an ancillary services Fano-factor (FF), are calculated based on the ancillary services average, the ancillary services standard deviation, and the ancillary services variance obtained in the previous steps. The ancillary services covariance (CoV) is calculated by dividing the ancillary services standard deviation with the ancillary services average. Similarly, the ancillary services Fano-factor (FF) is calculated by dividing the ancillary services variance with the ancillary services average.

A correlation factor is then calculated based on the ancillary services covariance and the ancillary services Fano-factor, using a correlation equation. The correlation factor defines a correlation among the one or more relevant ancillary service bundles for each vacant room. The correlation equation may be mathematically expressed as in equation 1:

$$Correlation factor = ( ( \frac{F F}{C o V * C o V} ) - 1 ) / 2 \qquad ( 1 )$$

Next, (i) a lower bound, and (ii) an upper bound, are calculated for each of the one or more relevant ancillary service bundles, using the correlation factor and the MAP score associated with each of the one or more relevant ancillary service bundles. In an embodiment, the MAP score associated with each of the one or more relevant ancillary service bundles, is calculated as explained at step 310 of the method 300. The lower bound and the upper bound are calculated for each of the one or more relevant ancillary service bundles, using the lower bound formula and the upper bound formula, as mentioned in equation 2 and 3, respectively:

$$Lower bound = MAP score - ( MAP score ⋆ \frac{CoV \%}{100} ) \qquad ( 2 )$$

$$Upper bound = MAP score + ( MAP score ⋆ \frac{CoV \%}{100} ) \qquad ( 3 )$$

Next, each of the one or more ancillary service bundles, is classified based on the lower bound and the upper bound associated with the relevant ancillary service bundle, to calculate a deterministic offer for each of the one or more relevant ancillary service bundles. More specifically, the relevant ancillary service bundles having the same or similar lower bound are grouped to one basket (one category). Similarly, the relevant ancillary service bundles having the same or similar upper bound are grouped to another basket (another category), and so on.

The deterministic offer for each of the one or more relevant ancillary service bundles, is calculated based on the classification and a maximum deterministic offer defined for each of the one or more ancillary service bundles. The deterministic offer for each of the one or more relevant ancillary service bundles, represents the standard offer provided by the hotel for the associated relevant ancillary service bundle. The maximum deterministic offer for each of the one or more ancillary service bundles, is defined by the hotel based on possible price offer for each ancillary service present in the relevant ancillary service bundle.

Next, a fluidic offer for each of the one or more relevant ancillary service bundles, is determined based on the deterministic offer calculated for each of the one or more relevant ancillary service bundles. Table 2 shows an exemplary fluidic offer and the exemplary deterministic offer for the exemplary relevant ancillary service bundles shown in table 1.

TABLE 2

| Relevant ancillary | Relevant ancillary | | Deterministic |
|---|---|---|---|
| service bundle number | service bundle | Fluidic Offer | Offer |
| Bundle 1 | {BF, Dinner, Saloon, | (20 +18 + 16 + 14 + 12)/5 = 16% | 20% |
| | SPA} | | |
| Bundle 2 | {BF, Dinner, Saloon} | (20 + 18 + 16 + 14 + 12 + 10)/6 = 15% | 18% |
| Bundle 3 | {BF, Dinner, SPA} | (20 + 18 + 16 + 14 + 12 + 10)/6 = 15% | 16% |
| Bundle 4 | {BF, Dinner} | (20 + 18 + 16 + 14 + 12 + 10 + 8)/7 = 14% | 14% |
| Bundle 5 | {BF, Saloon, SPA} | (20 + 18 + 16 + 14 + 12 + 10 + 8 + 6)/8 = 13% | 12% |
| Bundle 6 | {BF, Saloon} | (20 + 18 + 16 + 14 + 12 + 10 + 8 + 6)/8 = 13% | 10% |
| Bundle 7 | {BF, SPA} | (20 + 18 + 16 + 14 + 12 + 10 + 8 + 6)/8 = 13% | 8% |
| Bundle 8 | {BF} | (18 + 16 + 14 + 12 + 10 + 8 + 6)/7 = 12% | 6% |

Note from table 2 that, the fluidic offer for each relevant ancillary service bundle is calculated based on the deterministic offer associated with relevant ancillary service bundle and the number of relevant ancillary service bundles present in the associated basket which is made based on the classification as explained in the previous step. If the relevant ancillary service bundle belongs to only one basket, then the fluidic offer for that bundle will be same as the deterministic offer for that basket. If the relevant ancillary service bundle belongs to more than one basket then the fluidic offer for that bundle will be equal to the average of the deterministic offer of all those baskets.

A negotiated offer value for each of the one or more relevant ancillary service bundles, is then calculated based on the deterministic offer and the fluidic offer associated with each of the one or more ancillary service bundles. The negotiated offer value for each of the one or more relevant ancillary service bundles is calculated using equation 4:

Negotiated offer value=(fluidic offer+deterministic offer)/2 (3)

Table 3 shows an exemplary negotiated offer value for the exemplary relevant ancillary service bundles shown in table 2.

TABLE 3

| Relevant ancillary | Relevant ancillary | Fluidic | Deterministic | Negotiated |
|---|---|---|---|---|
| service bundle number | service bundle | Offer | Offer | offer value |
| Bundle 1 | {BF, Dinner, Saloon, | 16% | 20% | 18% |
| | SPA} | | | |
| Bundle 2 | {BF, Dinner, Saloon} | 15% | 18% | 16.5% |
| Bundle 3 | {BF, Dinner, SPA} | 15% | 16% | 15.5% |
| Bundle 4 | {BF, Dinner} | 14% | 14% | 14% |
| Bundle 5 | {BF, Saloon, SPA} | 13% | 12% | 12.5% |
| Bundle 6 | {BF, Saloon} | 13% | 10% | 11.5% |
| Bundle 7 | {BF, SPA} | 13% | 8% | 10.5% |
| Bundle 8 | {BF} | 12% | 6% | 9% |

A stochastic offer price for each of the one or more ancillary service bundles, is calculated based on the negotiated offer value corresponding to the ancillary service bundle and an actual price value corresponding to the ancillary service bundle and a relevant stochastic ancillary service bundle price for each of the one or more ancillary service bundles, based on the stochastic offer price corresponding to the ancillary service bundle and the actual price value corresponding to the ancillary service bundle. Table 4 shows exemplary stochastic offer price and the relevant stochastic ancillary service bundle price for the exemplary relevant ancillary service bundles shown in table 3.

TABLE 4

| | | | | | Relevant stochastic |
|---|---|---|---|---|---|
| Relevant ancillary | Relevant ancillary | Negotiated | Actual | Stochastic | ancillary service |
| service bundle number | service bundle | offer value | price | offer price | bundle price |
| Bundle 1 | {BF, Dinner, Saloon, | 18% | 5000 | 900 | 4100 |
| | SPA} | | | | |
| Bundle 2 | {BF, Dinner, Saloon} | 16.50% | 4500 | 743 | 3758 |
| Bundle 3 | {BF, Dinner, SPA} | 15.50% | 4500 | 698 | 3803 |
| Bundle 4 | {BF, Dinner} | 14% | 4000 | 560 | 3440 |
| Bundle 5 | {BF, Saloon, SPA} | 12.50% | 4500 | 563 | 3938 |
| Bundle 6 | {BF, Saloon} | 11.50% | 4000 | 460 | 3540 |
| Bundle 7 | {BF, SPA} | 10.50% | 3000 | 315 | 2685 |
| Bundle 8 | {BF} | 9% | 2500 | 225 | 2275 |

Further, a linear offer for each of the one or more relevant ancillary service bundles, is calculated based on the actual price value corresponding to the relevant ancillary service bundle and the deterministic offer corresponding to the relevant ancillary service bundle, and accordingly, a relevant linear ancillary service bundle price for each of the one or more ancillary service bundles, is calculated based on the actual price value corresponding to the relevant ancillary service bundle and the linear offer corresponding to the relevant ancillary service bundle. Table 5 shows exemplary linear offer and the relevant linear ancillary service bundle price for the exemplary relevant ancillary service bundles shown in table 4.

TABLE 5

| | | | | | Relevant linear |
|---|---|---|---|---|---|
| Relevant ancillary | Relevant ancillary | Deterministic | Actual | Linear | ancillary service |
| service bundle number | service bundle | Offer | price | offer | bundle price |
| Bundle 1 | {BF, Dinner, Saloon, | 20% | 5000 | 1000 | 4000 |
| | SPA} | | | | |
| Bundle 2 | {BF, Dinner, Saloon} | 18% | 4500 | 810 | 3690 |
| Bundle 3 | {BF, Dinner, SPA} | 16% | 4500 | 720 | 3780 |
| Bundle 4 | {BF, Dinner} | 14% | 4000 | 560 | 3440 |
| Bundle 5 | {BF, Saloon, SPA} | 12% | 4500 | 540 | 3960 |
| Bundle 6 | {BF, Saloon} | 10% | 4000 | 400 | 3600 |
| Bundle 7 | {BF, SPA} | 8% | 3000 | 240 | 2760 |
| Bundle 8 | {BF} | 6% | 2500 | 150 | 2350 |

Lastly, the fluidic pricing for each of the one or more relevant ancillary service bundles, is determined, based on (i) the relevant stochastic ancillary service bundle price for each of the one or more ancillary service bundles, and (ii) the relevant linear ancillary service bundle price for each of the one or more ancillary service bundles.

At step 314 of the method 300, the one or more hardware processors 104 of the system 100 are configured to present the personalized hospitality offerings to the guest, using (i) the one or more hotels identified at step 304 of the method 300, (ii) the one or more vacant rooms identified at step 306 of the method 300, available from the one or more hotels, (iii) the one or more relevant ancillary service bundles formed at step 310 of the method 300 for each vacant room of the one or more vacant rooms, and (iv) the fluidic pricing for each of the one or more relevant ancillary service bundles, determined at step 312 of the method 300, for each vacant room of the one or more vacant rooms. Table 6 shows the exemplary personalized hospitality offerings to the guest, for hotel X and hotel Y and such offering are presented for all the hotels identified at step 304 of the method 300. The guest may choose the room (based on type of occupancy) and the ancillary service bundles among the options, based on the requirement.

TABLE 6

| Hotel | Type of | Ancillary service | |
|---|---|---|---|
| Name | occupancy | bundle | Price |
| Hotel X | Room A | {BF, Dinner, Saloon, | 4100 |
| | | SPA} | |
| | | {BF, Dinner, Saloon} | 3758 |
| | | {BF, Dinner, SPA} | 3803 |
| | Room B | {BF, Dinner} | 3440 |
| | | {BF, Saloon, SPA} | 3938 |
| Hotel Y | Room A | {BF, Saloon} | 3540 |
| | | {BF, SPA} | 2685 |

The methods and systems of the present disclosure for optimizing personalized hospitality offerings, employs a plurality of prediction models (bucket of prediction models) namely (i) pre-trained hotel prediction model for predicting one or more hotels present in the destination city, based on the input requirements of the customer, (ii) the pre-trained room prediction model for predicting the one or more vacant rooms from the one or more hotels, and (iii) the pre-trained ancillary services prediction model for the predicting the one or more ancillary services available for the one or more vacant rooms. Each prediction model is separately trained on the features obtained from the unstructured historical training data, using a feature extraction technique. The prediction from the bucket of prediction models is a cascaded output and hence is accurate and effective for forming the relevant ancillary service bundles for each vacant room. The fluidic pricing mechanism determines fluidic pricing and offers for multiple relevant ancillary service bundles, which results in multiple products and services, which may suit mostly to the diverse customers. The multiple products and services may be further optimized in different seasons and based on the customization required by the customer. Further, the fluidic pricing and offers may further be customized for type of customer or the guest, such as loyal customer, privileged customer, and so on.

Though the present disclosure is described in detail for optimizing the personalized hospitality offerings, the scope of the present disclosure is not limited to other business segments, such as restaurants, on-line ticket reservations, and so on, with minimal changes in the methods and systems of the present disclosure.

The embodiments of present disclosure herein address unresolved problem of end-to-end technique for optimizing the personalized hospitality offerings. The embodiments herein provide a plurality of prediction models instead of a single prediction model, for predicting the accommodation to the guest based on the requirement. Further, the embodiment herein provides the fluidic pricing mechanism comprising the stochastic pricing offers and the liner pricing offers to give more dynamics to optimize the personalized hospitality offerings.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

It is to be understood that the scope of the protection is extended to such a program and in addition to a computer-readable means having a message therein; such computer-readable storage means contain program-code means for implementation of one or more steps of the method, when the program runs on a server or mobile device or any suitable programmable device. The hardware device can be any kind of device which can be programmed including e.g. any kind of computer like a server or a personal computer, or the like, or any combination thereof. The device may also include means which could be e.g. hardware means like e.g. an application-specific integrated circuit (ASIC), a field-programmable gate array (FPGA), or a combination of hardware and software means, e.g. an ASIC and an FPGA, or at least one microprocessor and at least one memory with software modules located therein. Thus, the means can include both hardware means and software means. The method embodiments described herein could be implemented in hardware and software. The device may also include software means. Alternatively, the embodiments may be implemented on different hardware devices, e.g. using a plurality of CPUs.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer readable medium can be any apparatus that can comprise, store, communicate, propagate, or transport the program for use by or in connection with the instruction execution system, apparatus, or device.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims (when included in the specification), the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored.

Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A processor-implemented method for optimizing personalized hospitality offerings, the method comprising the steps of:
receiving, via one or more hardware processors, one or more input parameters for the personalized hospitality offerings, from a guest, wherein the one or more input parameters comprising: a number of adults, a number of children, a destination country, a destination city, a type of occupancy, date and time of arrival, date and time of departure, one or more demographic particulars of each adult, one or more demographic particulars of each child, nationality of each adult, nationality of each child, a geographic location of each adult, and a geographic location of each child;
identifying, via the one or more hardware processors, one or more hotels available in the destination city, based on the one or more input parameters, using a pre-trained hotel prediction model;
identifying, via the one or more hardware processors, one or more vacant rooms available from the one or more hotels, based on the one or more input parameters, using a pre-trained room prediction model;
identifying, via the one or more hardware processors, one or more ancillary services associated with each vacant room of the one or more vacant rooms, based on the one or more input parameters, using a pre-trained ancillary services prediction model, wherein the one or more ancillary services associated with each vacant room represents the ancillary services available with each vacant room;
forming, via the one or more hardware processors, one or more relevant ancillary service bundles, for each vacant room of the one or more vacant rooms, based on the one or more ancillary services associated with each vacant room and using a mean average precision (MAP) technique;
determining, via the one or more hardware processors, a fluidic pricing for each of the one or more relevant ancillary service bundles, for each vacant room of the one or more vacant rooms, using a fluidic pricing procedure; and
presenting, via the one or more hardware processors, the personalized hospitality offerings to the guest, using (i) the one or more hotels, (ii) the one or more vacant rooms available from the one or more hotels, (iii) the one or more relevant ancillary service bundles for each vacant room of the one or more vacant rooms, and (iv) the fluidic pricing for each of the one or more relevant ancillary service bundles, for each vacant room of the one or more vacant rooms.

2. The method of claim 1, wherein the pre-trained hotel prediction model is obtained by:
receiving a historical hotel reservation training dataset comprising a plurality of historical hotel records, wherein each historical hotel record represents a hotel reservation data associated with a past guest and comprising at least one of: a destination country of the past guest, a destination city of the past guest, a hotel name availed by the past guest, date and time of arrival of the past guest, nationality of the past guest, type of occupancy reserved by the past guest;
pre-processing the historical hotel reservation training dataset to obtain a pre-processed historical hotel reservation training dataset comprising a plurality of pre-processed historical hotel records, wherein each pre-processed historical hotel record represents a pre-processed reservation data associated with the past guest, and wherein the pre-processing comprises at least one of: cleaning, imputing missing data, and outliers removal;
extracting a plurality of first features from the plurality of pre-processed historical hotel records, using a feature extraction technique, wherein each first feature is extracted from each pre-processed historical hotel record; and
training a random forest model with the plurality of first features, to obtain the pre-trained hotel prediction model.

3. The method of claim 1, wherein the pre-trained room prediction model is obtained by:
receiving a historical room reservation training dataset comprising a plurality of room historical records, wherein each historical room record represents a room reservation data associated with a past guest and comprising at least one of: a destination country of the past guest, a destination city of the past guest, a hotel name availed by the past guest, a type of occupancy availed by the past guest in the hotel, date and time of arrival of the past guest, and nationality of the past guest;
pre-processing the historical room reservation training dataset to obtain a pre-processed historical room reservation training dataset comprising a plurality of pre-processed historical room records, wherein each pre-processed historical room record represents a pre-processed room reservation data associated with the past guest, and wherein the pre-processing comprises at least one of: cleaning, imputing missing data, and outliers removal;
extracting a plurality of second features from the plurality of pre-processed historical room records, using a feature extraction technique, wherein each second feature is extracted from each pre-processed historical room record; and
training a random forest model with the plurality of second features, to obtain the pre-trained room prediction model.

4. The method of claim 1, wherein the pre-trained ancillary services prediction model is obtained by:
receiving a historical ancillary services reservation training dataset comprising a plurality of historical ancillary services reservation records, wherein each historical ancillary services reservation record represents an ancillary services reservation data associated with a past guest, and comprising at least one of: a destination country of the past guest, a destination city of the past guest, a hotel name availed by the past guest, date and time of arrival of the past guest, date and time of departure of the past guest, nationality of the past guest, type of occupancy availed by the past guest in the hotel, the one or more demographic particulars of the past guest, the nationality of the past guest, and one or more ancillary services availed by the past guest;
pre-processing the historical ancillary services reservation training dataset to obtain a pre-processed historical ancillary services reservation training dataset comprising a plurality of pre-processed historical ancillary services reservation records, wherein each pre-processed historical ancillary services reservation record represents a pre-processed ancillary services reservation data associated with the past guest, and wherein the pre-processing comprises at least one of: cleaning, imputing missing data, and outliers removal;
extracting a plurality of third features from the plurality of pre-processed historical ancillary services reservation records, using a feature extraction technique, wherein each third feature is extracted from each pre-processed historical ancillary services reservation record; and
training a XG-boost model with the plurality of third features, to obtain the pre-trained ancillary services prediction model.

5. The method of claim 1, wherein forming the one or more relevant ancillary service bundles, for each vacant room, based on the one or more ancillary services associated with each vacant room and using the mean average precision (MAP) technique, comprises:
assigning a rank to each of the one or more ancillary services associated with each vacant room, based on a population score of each of the one or more ancillary services, wherein the population score of each of the one or more ancillary services is obtained by a pre-trained population score prediction model;
forming a plurality of ancillary service bundles, for each vacant room, based on the one or more ancillary services associated with each vacant room;
calculating a MAP score for each ancillary service bundle of the plurality of ancillary service bundles, for each vacant room, using the rank assigned to each of the one or more ancillary services associated with the vacant room; and
forming the one or more ancillary service bundles out of the plurality of ancillary service bundles, having the MAP score for each ancillary service bundle of the plurality of ancillary service bundles greater than a predefined threshold, for each vacant room;
defining an average precision (AP) score, for each vacant room of the one or more vacant rooms, using an average precision technique;
calculating a morphism score for each of the one or more ancillary service bundles, for each vacant room, based on the average precision (AP) score for each vacant room and the MAP score for the corresponding ancillary service bundle associated with the vacant room, using a predefined morphism criterion; and
determining one or more relevant ancillary service bundles, from the one or more ancillary service bundles, based on the relevant ancillary service bundle score for each of the one or more ancillary service bundles.

6. The method of claim 1, wherein determining the fluidic pricing for each of the one or more relevant ancillary service bundles, for each vacant room of the one or more vacant rooms, using the fluidic pricing procedure, comprises:
calculating a number of ancillary services present in each of the one or more relevant ancillary service bundles, for each vacant room of the one or more vacant rooms;
calculating an ancillary services average, based on the number of ancillary services present in each of the one or more relevant ancillary service bundles, for each vacant room;
calculating (i) an ancillary services standard deviation and (ii) an ancillary services variance, based on the ancillary services average;
calculating (i) an ancillary services covariance and (ii) an ancillary services Fano-factor, based on the ancillary services average, the ancillary services standard deviation, and the ancillary services variance;
calculating a correlation factor, based on the ancillary services covariance and the ancillary services Fano-factor, using a correlation equation;
calculating (i) a lower bound, and (ii) an upper bound, for each of the one or more relevant ancillary service bundles, using the correlation factor and a MAP score associated with each of the one or more relevant ancillary service bundles;
classifying each of the one or more ancillary service bundles, based on the lower bound, and the upper bound associated with the relevant ancillary service bundle, to calculate a deterministic offer for each of the one or more relevant ancillary service bundles, based on the classification and a maximum deterministic offer defined for each of the one or more ancillary service bundles;
determining a fluidic offer for each of the one or more relevant ancillary service bundles, based on the deterministic offer calculated for each of the one or more relevant ancillary service bundles;
calculating a negotiated offer value for each of the one or more relevant ancillary service bundles, based on the deterministic offer and the fluidic offer associated with each of the one or more ancillary service bundles;
calculating a stochastic offer price for each of the one or more ancillary service bundles, based on the negotiated offer value corresponding to the ancillary service bundle and an actual price value corresponding to the ancillary service bundle;
calculating a relevant stochastic ancillary service bundle price for each of the one or more ancillary service bundles, based on the stochastic offer price corresponding to the ancillary service bundle and the actual price value corresponding to the ancillary service bundle;
calculating a linear offer for each of the one or more relevant ancillary service bundles, based on the actual price value corresponding to the relevant ancillary service bundle and the deterministic offer corresponding to the relevant ancillary service bundle;
calculating a relevant linear ancillary service bundle price for each of the one or more ancillary service bundles, based on the actual price value corresponding to the relevant ancillary service bundle and the linear offer corresponding to the relevant ancillary service bundle; and
determining the fluidic pricing for each of the one or more relevant ancillary service bundles, based on (i) the relevant stochastic ancillary service bundle price for each of the one or more ancillary service bundles, and (ii) the relevant linear ancillary service bundle price for each of the one or more ancillary service bundles.

7. A system for optimizing personalized hospitality offerings, the system comprising:
a memory storing instructions;
one or more Input/Output (I/O) interfaces; and
one or more hardware processors coupled to the memory via the one or more I/O interfaces, wherein the one or more hardware processors are configured by the instructions to:
receive one or more input parameters for the personalized hospitality offerings, from a guest, wherein the one or more input parameters comprising: a number of adults, a number of children, a destination country, a destination city, a type of occupancy, date and time of arrival, date and time of departure, one or more demographic particulars of each adult, one or more demographic particulars of each child, nationality of each adult, nationality of each child, a geographic location of each adult, and a geographic location of each child;
identify one or more hotels available in the destination city, based on the one or more input parameters, using a pre-trained hotel prediction model;
identify one or more vacant rooms available from the one or more hotels, based on the one or more input parameters, using a pre-trained room prediction model;
identify one or more ancillary services associated with each vacant room of the one or more vacant rooms, based on the one or more input parameters, using a pre-trained ancillary services prediction model, wherein the one or more ancillary services associated with each vacant room represents the ancillary services available with each vacant room;
form one or more relevant ancillary service bundles, for each vacant room of the one or more vacant rooms, based on the one or more ancillary services associated with each vacant room and using the mean average precision (MAP) technique;
determine a fluidic pricing for each of the one or more relevant ancillary service bundles, for each vacant room of the one or more vacant rooms, using a fluidic pricing procedure; and
present the personalized hospitality offerings to the guest, using (i) the one or more hotels, (ii) the one or more vacant rooms available from the one or more hotels, (iii) the one or more relevant ancillary service bundles for each vacant room of the one or more vacant rooms, and (iv) the fluidic pricing for each of the one or more relevant ancillary service bundles, for each vacant room of the one or more vacant rooms.

8. The system of claim 7, wherein the one or more hardware processors are configured to obtain the pre-trained hotel prediction model, by:
receiving a historical hotel reservation training dataset comprising a plurality of hotel historical records, wherein each hotel historical record represents a hotel reservation data associated with a past guest and comprising at least one of: a destination country of the past guest, a destination city of the past guest, a hotel name availed by the past guest, date and time of arrival of the past guest, nationality of the past guest, type of occupancy reserved by the past guest;
pre-processing the historical hotel reservation training dataset to obtain a pre-processed historical hotel reservation training dataset comprising a plurality of pre-processed hotel historical records, wherein each pre-processed hotel historical record represents a pre-processed reservation data associated with the past guest, and wherein the pre-processing comprises at least one of: cleaning, imputing missing data, and outliers removal;
extracting a plurality of first features from the plurality of pre-processed hotel historical records, using a feature extraction technique, wherein each first feature is extracted from each pre-processed hotel historical record; and
training a random forest model with the plurality of first features, to obtain the pre-trained hotel prediction model.

9. The system of claim 7, wherein the one or more hardware processors are configured to obtain the pre-trained room prediction model, by:
receiving a historical room reservation training dataset comprising a plurality of room historical records, wherein each room historical record represents a room reservation data associated with a past guest and comprising at least one of: a destination country of the past guest, a destination city of the past guest, a hotel name availed by the past guest, a type of occupancy availed by the past guest in the hotel, date and time of arrival of the past guest, and nationality of the past guest;
pre-processing the historical room reservation training dataset to obtain a pre-processed historical room reservation training dataset comprising a plurality of pre-processed room historical records, wherein each pre-processed room historical record represents a pre-processed room reservation data associated with the past guest, and wherein the pre-processing comprises at least one of: cleaning, imputing missing data, and outliers removal;
extracting a plurality of second features from the plurality of pre-processed room historical records, using a feature extraction technique, wherein each second feature is extracted from each pre-processed room historical record; and
training a random forest model with the plurality of second features, to obtain the pre-trained room prediction model.

10. The system of claim 7, wherein the one or more hardware processors are configured to obtain the pre-trained ancillary services prediction model, by:
receiving a historical ancillary services reservation training dataset comprising a plurality of historical ancillary services reservation records, wherein each historical ancillary services reservation records represents an ancillary services reservation data associated with a past guest, and comprising at least one of: a destination country of the past guest, a destination city of the past guest, a hotel name availed by the past guest, date and time of arrival of the past guest, date and time of departure of the past guest, nationality of the past guest, type of occupancy availed by the past guest in the hotel, and one or more ancillary services availed by the past guest;
pre-processing the historical ancillary services reservation training dataset to obtain a pre-processed historical ancillary services reservation training dataset comprising a plurality of pre-processed historical ancillary services reservation records, wherein each pre-processed historical ancillary services reservation record represents a pre-processed ancillary services reservation data associated with the past guest, and wherein the pre-processing comprises at least one of: cleaning, imputing missing data, and outliers removal;
extracting a plurality of third features from the plurality of pre-processed historical ancillary services reservation records, using a feature extraction technique, wherein each third feature is extracted from each pre-processed historical ancillary services reservation record; and
training a XG-boost model with the plurality of third features, to obtain the pre-trained ancillary service prediction model.

11. The system of claim 7, wherein the one or more hardware processors are configured to form the one or more relevant ancillary service bundles, for each vacant room, based on the one or more ancillary services associated with each vacant room and using the mean average precision (MAP) technique, by:
assigning a rank to each of the one or more ancillary services associated with each vacant room, based on a population score of each of the one or more ancillary services, wherein the population score of each of the one or more ancillary services is obtained by a pre-trained population score prediction model;
forming a plurality of ancillary service bundles, for each vacant room, based on the one or more ancillary services associated with each vacant room;
calculating a MAP score for each ancillary service bundle of the plurality of ancillary service bundles, for each vacant room, using the rank assigned to each of the one or more ancillary services associated with the vacant room; and
forming the one or more ancillary service bundles out of the plurality of ancillary service bundles, having the MAP score for each ancillary service bundle of the plurality of ancillary service bundles greater than a predefined threshold, for each vacant room;
defining an average precision (AP) score, for each vacant room of the one or more vacant rooms, using an average precision technique;
calculating a morphism score for each of the one or more ancillary service bundles, for each vacant room, based on the average precision (AP) score for each vacant room and the MAP score for the corresponding ancillary service bundle associated with the vacant room, using a predefined morphism criterion; and
determining one or more relevant ancillary service bundles, from the one or more ancillary service bundles, based on the relevant ancillary service bundle score for each of the one or more ancillary service bundles.

12. The system of claim 7, wherein the one or more hardware processors are configured to determine the fluidic pricing for each of the one or more relevant ancillary service bundles, for each vacant room of the one or more vacant rooms, using the fluidic pricing procedure, by:
calculating a number of ancillary services present in each of the one or more relevant ancillary service bundles, for each vacant room of the one or more vacant rooms;
calculating an ancillary services average, based on the number of ancillary services present in each of the one or more relevant ancillary service bundles, for each vacant room;
calculating (i) an ancillary services standard deviation and (ii) an ancillary services variance, based on the ancillary services average;
calculating (i) an ancillary services covariance and (ii) an ancillary services Fano-factor, based on the ancillary services average, the ancillary services standard deviation, and the ancillary services variance;
calculating a correlation factor, based on the ancillary services covariance and the ancillary services Fano-factor, using a correlation equation;
calculating (i) a lower bound, and (ii) an upper bound, for each of the one or more relevant ancillary service bundles, using the correlation factor and a MAP score associated with each of the one or more relevant ancillary service bundles;
classifying each of the one or more ancillary service bundles, based on the lower bound, and the upper bound associated ancillary service bundle, to calculate a deterministic offer for each of the one or more relevant ancillary service bundles, based on the classification and a maximum deterministic offer defined for each of the one or more ancillary service bundles;
determining a fluidic offer for each of the one or more relevant ancillary service bundles, based on the deterministic offer calculated for each of the one or more relevant ancillary service bundles;
calculating a negotiated offer value for each of the one or more relevant ancillary service bundles, based on the deterministic offer and the fluidic offer associated with each of the one or more ancillary service bundles;
calculating a stochastic offer price for each of the one or more ancillary service bundles, based on the negotiated offer value corresponding to the ancillary service bundle and an actual price value corresponding to the ancillary service bundle;
calculating a relevant stochastic ancillary service bundle price for each of the one or more ancillary service bundles, based on the stochastic offer price corresponding to the ancillary service bundle and the actual price value corresponding to the ancillary service bundle;
calculating a linear offer for each of the one or more relevant ancillary service bundles, based on the actual price value corresponding to the relevant ancillary service bundle and the deterministic offer corresponding to the relevant ancillary service bundle;
calculating a relevant linear ancillary service bundle price for each of the one or more ancillary service bundles, based on the actual price value corresponding to the relevant ancillary service bundle and the linear offer corresponding to the relevant ancillary service bundle; and
determining the fluidic pricing for each of the one or more relevant ancillary service bundles, based on (i) the relevant stochastic ancillary service bundle price for each of the one or more ancillary service bundles, and (ii) the relevant linear ancillary service bundle price for each of the one or more ancillary service bundles.

13. One or more non-transitory machine-readable information storage mediums comprising one or more instructions which when executed by one or more hardware processors cause:
receiving, one or more input parameters for the personalized hospitality offerings, from a guest, wherein the one or more input parameters comprising: a number of adults, a number of children, a destination country, a destination city, a type of occupancy, date and time of arrival, date and time of departure, one or more demographic particulars of each adult, one or more demographic particulars of each child, nationality of each adult, nationality of each child, a geographic location of each adult, and a geographic location of each child;
identifying, one or more hotels available in the destination city, based on the one or more input parameters, using a pre-trained hotel prediction model;
identifying, one or more vacant rooms available from the one or more hotels, based on the one or more input parameters, using a pre-trained room prediction model;
identifying, one or more ancillary services associated with each vacant room of the one or more vacant rooms, based on the one or more input parameters, using a pre-trained ancillary services prediction model, wherein the one or more ancillary services associated with each vacant room represents the ancillary services available with each vacant room;
forming, one or more relevant ancillary service bundles, for each vacant room of the one or more vacant rooms, based on the one or more ancillary services associated with each vacant room and using a mean average precision (MAP) technique;
determining, a fluidic pricing for each of the one or more relevant ancillary service bundles, for each vacant room of the one or more vacant rooms, using a fluidic pricing procedure; and
presenting, the personalized hospitality offerings to the guest, using (i) the one or more hotels, (ii) the one or more vacant rooms available from the one or more hotels, (iii) the one or more relevant ancillary service bundles for each vacant room of the one or more vacant rooms, and (iv) the fluidic pricing for each of the one or more relevant ancillary service bundles, for each vacant room of the one or more vacant rooms.

14. The one or more non-transitory machine-readable information storage mediums of claim 13, wherein the pre-trained hotel prediction model is obtained by:
receiving a historical hotel reservation training dataset comprising a plurality of historical hotel records, wherein each historical hotel record represents a hotel reservation data associated with a past guest and comprising at least one of: a destination country of the past guest, a destination city of the past guest, a hotel name availed by the past guest, date and time of arrival of the past guest, nationality of the past guest, type of occupancy reserved by the past guest;
pre-processing the historical hotel reservation training dataset to obtain a pre-processed historical hotel reservation training dataset comprising a plurality of pre-processed historical hotel records, wherein each pre-processed historical hotel record represents a pre-processed reservation data associated with the past guest, and wherein the pre-processing comprises at least one of: cleaning, imputing missing data, and outliers removal;
extracting a plurality of first features from the plurality of pre-processed historical hotel records, using a feature extraction technique, wherein each first feature is extracted from each pre-processed historical hotel record; and
training a random forest model with the plurality of first features, to obtain the pre-trained hotel prediction model.

15. The one or more non-transitory machine-readable information storage mediums of claim 13, wherein the pre-trained room prediction model is obtained by:
receiving a historical room reservation training dataset comprising a plurality of room historical records, wherein each historical room record represents a room reservation data associated with a past guest and comprising at least one of: a destination country of the past guest, a destination city of the past guest, a hotel name availed by the past guest, a type of occupancy availed by the past guest in the hotel, date and time of arrival of the past guest, and nationality of the past guest;
pre-processing the historical room reservation training dataset to obtain a pre-processed historical room reservation training dataset comprising a plurality of pre-processed historical room records, wherein each pre-processed historical room record represents a pre-processed room reservation data associated with the past guest, and wherein the pre-processing comprises at least one of: cleaning, imputing missing data, and outliers removal;
extracting a plurality of second features from the plurality of pre-processed historical room records, using a feature extraction technique, wherein each second feature is extracted from each pre-processed historical room record; and
training a random forest model with the plurality of second features, to obtain the pre-trained room prediction model.

16. The one or more non-transitory machine-readable information storage mediums of claim 13, wherein the pre-trained ancillary services prediction model is obtained by:
receiving a historical ancillary services reservation training dataset comprising a plurality of historical ancillary services reservation records, wherein each historical ancillary services reservation record represents an ancillary services reservation data associated with a past guest, and comprising at least one of: a destination country of the past guest, a destination city of the past guest, a hotel name availed by the past guest, date and time of arrival of the past guest, date and time of departure of the past guest, nationality of the past guest, type of occupancy availed by the past guest in the hotel, the one or more demographic particulars of the past guest, the nationality of the past guest, and one or more ancillary services availed by the past guest;
pre-processing the historical ancillary services reservation training dataset to obtain a pre-processed historical ancillary services reservation training dataset comprising a plurality of pre-processed historical ancillary services reservation records, wherein each pre-processed historical ancillary services reservation record represents a pre-processed ancillary services reservation data associated with the past guest, and wherein the pre-processing comprises at least one of: cleaning, imputing missing data, and outliers removal;
extracting a plurality of third features from the plurality of pre-processed historical ancillary services reservation records, using a feature extraction technique, wherein each third feature is extracted from each pre-processed historical ancillary services reservation record; and
training a XG-boost model with the plurality of third features, to
obtain the pre-trained ancillary services prediction model.
